(19) United States
(12) Patent Application Publication
(10) Pub. No.: US 2024/0150594 A1
(43) Pub. Date: May 9, 2024

(54) MAR AND SCUFF RESISTANT COATING FORMULATIONS

(71) Applicant: BEHR PROCESS CORPORATION, Santa Ana, CA (US)

(72) Inventors: Jason Robert JONES, Irvine, CA (US); Tri TRAN, Santa Ana, CA (US); Gregory Allen WILLIAMS, Laguna Beach, CA (US)

(73) Assignee: BEHR PROCESS CORPORATION, Santa Ana, CA (US)

(21) Appl. No.: 18/281,394

(22) PCT Filed: Mar. 9, 2022
(86) PCT No.: PCT/US2022/019520

§ 371 Date: Sep. 11, 2023

Related U.S. Application Data
(60) Provisional application No. 63/159,592, filed on Mar. 11, 2021.

(51) Int. Cl. C09D 7/65; C09D 5/02; C09D 133/04

(52) U.S. Cl. CPC C09D 7/65; C09D 5/024; C09D 133/04

(57) ABSTRACT

A scuff and mar-resistant paint composition includes a base paint formulation and a slip additive dispersed in the base paint formulation. Characteristically, the slip additive has a surface energy less than about 30 mJ/m². Advantageously, the slip additive being in a sufficient amount such that slip resistance of a coating formed from the scuff and mar-resistant paint composition is decreased compared to a coating formed from the base paint formulation. A method of upgrading a manufactured base paint formulation is also provided.

### CROSS-REFERENCE TO RELATED APPLICATIONS

This application claims the benefit of U.S. provisional application Ser. No. 63/159,592 filed Mar. 11, 2021, the disclosure of which is hereby incorporated in its entirety by reference herein.

### TECHNICAL FIELD

In at least one aspect, a scuff and mar-resistant paint composition provides a significant improvement to the scuff and mar resistance of architectural coatings.

### BACKGROUND

Architectural coatings formed from oil and water-based paint compositions are ubiquitous. Although the prior art coatings work well, making of the coatings formed are prone to scuffing and marring. International patent WO2019160681A1 provides a solution to the scuffing and marring problem. However, this solution requires an entirely new resin to be made and used as a primary ingredient of the formulation.

Accordingly, there is a need for paint compositions with improved scuff and mar resistance.

### SUMMARY

In at least one aspect, the present invention a scuff and mar-resistant paint composition is provided. The scuff and mar-resistant paint composition include a base paint formulation and a slip additive dispersed in the base paint formulation. Characteristically, the slip additive has a surface energy less than about 40 mJ/m². Advantageously, the slip additive is in a sufficient amount such that the slip resistance of a coating formed from the scuff and mar-resistant paint composition is decreased compared to a coating formed from the base paint formulation.

In another aspect, a method of upgrading a manufactured base paint formulation is provided. The method includes a step of receiving the manufactured base paint formulation. A slip additive is mixed into the manufactured base paint formulation. Characteristically, the slip additive has a surface energy less than about 40 mJ/m². Advantageously, the slip additive is in a sufficient amount such that slip resistance of a coating formed from the manufactured base paint formulation with the slip additive mixed therein is decreased compared to a coating formed from the manufactured base paint formulation without the slip additive.

In another aspect, a scuff and mar-resistant paint composition provides a significant improvement to the scuff and mar resistance of an architectural coating formulation by using additives that are broadly compatible with existing coatings formulations.

The foregoing summary is illustrative only and is not intended to be in any way limiting. In addition to the illustrative aspects, embodiments, and features described above, further aspects, embodiments, and features will become apparent by reference to the drawings and the following detailed description.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, —NO₂, —NH₂, —N(R′R″), —N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R″′ are C₁₋₁₀ alkyl or C₆₋₁₈ aryl groups, M⁺is a metal ion, and L⁻ is a negatively charged counter ion; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R″′ are C₁₋₁₀ alkyl or C₆₋₁₈ aryl groups, M⁺ is a metal ion, and L⁻ is a negatively charged counter ion; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

Throughout this application, where publications are referenced, the disclosures of these publications in their entireties are hereby incorporated by reference into this application to more fully describe the state of the art to which this invention pertains.

The term “scuff” refers to the typical marks or discoloration on walls caused by the scraping of shoes, bags, jackets, or other materials (European Coatings Journal, Jan 2020). Alternatively, it is described as rubbing or scaping one's foot over something.

The term “abrasion” means the wearing away of a surface.

The term “marring” refers to the disturbance of a surface that alters its appearance. Mar resistance is related to abrasion resistance, but there is one important difference. Abrasion may go deeply into the coating, whereas marring is usually a near-surface phenomenon; mars less than 0.5 mm deep can degrade the appearance.

In an embodiment, a scuff and mar-resistant paint composition is provided. The scuff and mar-resistant paint composition includes a base paint formulation and a slip additive dispersed in the base paint formulation. In this context, a “base paint formulation” refers to a complete paint formulation that can be used to form a coating on a substrate. Therefore, the base paint formulation can be a commercially available paint formulation. Characteristically, the slip additive has a surface energy less than about 40 mJ/m². In a refinement, the slip additive has a surface energy less than about, in increasing order of preference, 45 mJ/m², 40 mJ/m², 35 mJ/m², 30 mJ/m², 25 mJ/m², 22 mJ/m², or 20 mJ/m². The slip additive is in a sufficient amount such that slip resistance of a coating formed from the scuff and mar-resistant paint composition is decreased compared to a coating formed from the base paint formulation. In some refinements, the base paint formulation is a latex paint formulation or an acrylic paint formulation. Advantageously, the scuff and mar-resistant paint composition allows for paint coatings with scuff and mar resistance to be formed on a substrate. Although the scuff and mar-resistant paint composition is not restricted to any mechanism for achieving this result, it is believed that these benefits are realized through reduction of the frictional force when materials scuff or mar the surface of the coating.

Typically, the slip additive is present in an amount from about 0.2 to 3.0% of the total weight of the scuff and mar-resistant paint composition. In a refinement, the slip additive is present in an amount from about 0.5 to 2.0% of the total weight of the scuff and mar-resistant paint composition.

In a variation, the slip additive is a fluorinated slip additive or a silicone-containing slip additive. In a refinement, the slip additive is a resin. In another refinement, wherein the slip additive is a silicone acrylic hybrid. In still another refinement, the slip additive is a silicone emulsion. In still another refinement, the slip additive is polydimethylsiloxane. In yet another refinement, the slip additive is a blend of synthetic wax and polytetrafluoroethylene. Examples of slip additives are Silicone Acrylic Hybrids, Silicone Additives, and Synthetic Wax/PTFE Blends.

In another embodiment, a method of upgrading a manufactured base paint formulation is provided. The method includes a step of receiving (i.e., obtaining) the manufactured base paint formulation. A slip additive is mixed into the manufactured base paint formulation. The slip additive advantageously has a surface energy less than about 40 mJ/m². In a refinement, the slip additive has a surface energy less than about, in increasing order of preference, 45 mJ/m², 40 mJ/m², 35 mJ/m², 30 mJ/m², 25 mJ/m², 22 mJ/m², or 20 mJ/m². Characteristically, the slip additive is in a sufficient amount such that slip resistance of a coating formed from the manufactured base paint formulation with the slip additive mixed therein is decreased compared to a coating formed from the manufactured base paint formulation without the slip additive. In a refinement, the manufactured base paint formulation is a commercially available paint formulation. Typically, the slip additive is present in an amount from about 0.2 to 3.0% of the total weight of the sum of manufactured base paint formulation and slip additive. In a refinement, the slip additive is present in an amount from about 0.5 to 2.0% of the total weight of the sum of manufactured base paint formulation and slip additive. Details of the manufactured base paint formulation and the slip additive are the same as set forth above.

In general, the base paint formulations include a pigment, binder, liquid, and additives. Pigments provide color to paint and also make paint opaque and also adjust the gloss. The pigment can be of mineral or organic origin, although some pigments are artificially produced. Some pigments possess little or no bulk and must be fixed on a more solid, but at the same time transparent, substance or base. “Prime” pigments provide color and opacity (opaque coverage). The most common prime pigment is titanium dioxide, which is white and is used in latex and oil-based paints. Pigments can also add hiding properties to paint. Specialty or extender pigments provide bulk to the paint at a low cost. The extender pigments (e.g., alum or clay) are often chosen for their impact on properties like scrub resistance, stain resistance, and chalk resistance. These pigments are added to the paint to provide certain characteristics such as thickness, a certain level of gloss, and durability. Additional examples of pigments are azo dyes, phthalocyanine, anthraquinone dyes, inorganic pigments and carbon black, powdered metals, metal compounds (e.g., zinc phosphate), and combinations thereof. Examples of inorganic pigments include, but are not limited to, titanium oxide, calcium carbonate, talc, clay, iron oxides (black, yellow, and red), zinc oxide, and the like, and combinations thereof.

In the base paint formulations, the binder holds the pigment and adheres it to a surface. In latex paint formulations, the latex resin is the binder. Most commonly in latex paint, the binder is 100% acrylic, vinyl acrylic (polyvinyl acetate), or styrenated acrylic. Since pigment particles are usually insoluble, the pigment particles form a suspension in the binder. The binder “binds” the pigment into a continuous film and adheres to a coating formed therefrom to the surface. In the base paint formulations, liquids carry the pigment and binders. Moreover, the liquid is the part of the paint or coatings product that evaporates. The role of the liquid is to keep the paint in a fluid form for ease of application. Once applied to the surface, the liquid evaporates, leaving a uniform film, which then dries to form the paint coating. The liquid used is primarily determined by the solubility of the binder. In oil-based and alkyd paints, the liquid is typically an organic solvent, and in latex paints, the liquid is typically water.

The base paint formulation can also include one or more additives. In some variations, the paint composition optionally further includes a combination of paint additives selected from the group consisting of matting agents, rheology modifiers, surfactants, defoamers, organic solvents, pH adjusters, UV stabilizers, dispersants, coalescents, biocides, matting agents, opaque polymers, mildewcides, and the like, and combinations thereof. It should be appreciated that any combination of these paint additives can be used. It should also be appreciated that each specific additive may refer to a combination of such additives.

A particular example of a base latex paint formulation includes one or more acrylic polymers or acrylic copolymers, pigments, additives, and water. The one or more acrylic polymers or acrylic copolymers can be present in an amount from about 20 to 90 weight percent of the total weight of the base latex paint formulation, pigments can be present in an amount from about 1 to 40 weight percent of the total weight of the base latex paint formulation, and additives can be present in an amount from about 0.1 to 30 weight percent of the total weight of the base latex paint formulation with the balance being water. Such acrylic polymers or acrylic copolymers can be formed from one or more or any combination of monomers selected from the group consisting of methacrylate, methyl acrylate, ethyl acrylate, 2-chloroethyl vinyl ether, 2-ethylhexyl acrylate, hydroxyethyl methacrylate, butyl acrylate, butyl methacrylate, trimethylolpropane triacrylate, pentafluorophenyl methacrylate, pentafluorophenyl acrylate, 1,1,1,3,3,3-hexafluoroisopropylacrylate, bis-(2,2,2-trifluoroethyl) itaconate, bis-(1,1,1,3,3,3-hexafluoroisopropyl), 1H,1H,3H-hexafluorobutyl acrylate, 1H,1H,7H-dodecafluoroheptyl methacrylate, 2,2,2-trifluoroethyl acrylate, 2,2,2-trifluoroethyl methacrylate, aliphatic, fluorinated aliphatic, 1H,1H,2H,2H-Heptadecafluorodecyl methacrylate 532.2 acrylic, 1H,1H,2H,2H-heptadecafluorodecyl acrylate, 1H,1H,5H-octafluoropentyl acrylate, 1H,1H,3H-tetrafluoropropyl methacrylate, hexafluoro-iso-propyl methacrylate, 1H,1H,3H-hexafluorobutyl methacrylate, 1H,1H,5H-octafluoropentyl methacrylate, ethylene, propylene, 1-butylene, 2 butylene, vinyl acetate, functional monomers (e.g., phosphorous-containing monomers), acid group monomers, and combinations thereof. In a refinement, the base latex paint formulation independently includes 0.1 to 5 weight percent rheology modifiers, 0.01 to 3 weight percent surfactants, 0.01 to 5 weight percent defoamers, 0.01 to 3 weight percent dispersants, 0.1 to 3 weight percent coalescents, 0.01 to 5 weight percent biocides, 0.01 to 3 weight mildewcides, 0.01 to 3 weight pH adjusters, 0.1 to 10 weight percent opaque polymer, 0.2 to 40 matting agents, and combinations thereof. Typically, the additives are present in a combined total amount from about 0.1 to 50 weight percent of the total weight of base latex paint formulation. In a refinement, the additives are present in a combined total amount from about 0.1 to 30 weight percent of the total weight of base latex paint formulation.

The following examples illustrate the various embodiments of the present invention. Those skilled in the art will recognize many variations that are within the spirit of the present invention and the scope of the claims.

Tables 1 and 2 provide experiment results showing the improvement in mar resistance when the additive set forth above is added to a base paint formulation.

TABLE 1
Improvement of mar and scuff resistance after adding
silicone acrylic hybrid to control formula

| | Matte Deep | |
|---|---|---|
| Physical Testing | Control | With Additive |
| Mar Resistance | Control | + |
| Black Marking Resistance | Control | + |

TABLE 2
Improvement in scuff, mar, and denim dye transfer after
adding silicone emulsion to the control formula

| | | Matte Deep, | Matte Deep, | |
|---|---|---|---|---|
| | | with silicone | with silicone | |
| | | emulsion, | emulsion, | No |
| Notes | | High | Low | additives |
| Denim | Initial | 0.3/2.1/2.9 | 0.3/2.0/2.7 | 0.3/1.9/2.5 |
| Resistance | After | 0.3/2.1/3.6 | 0.3/2.0/3.4 | 0.3/1.9/3.0 |
| | Delta | 0.0/0.0/0.7 | 0.0/0.0/0.7 | 0.0/0.0/0.5 |
| | (delta E) | 0.71 | 0.94 | 2.19 |
| Scuff | (good) 5- | 4 | 4 | 2 |
| Resistance | 1 (worse) | | | |
| Mar Resistance | (weights)700 g | + | + | Control |

Tables 3 and 4 provide block resistance testing at room temperature (RT) and 120° F. for paint coatings made from some of the scuff and mar-resistant paint compositions set forth above. The block resistance can be determined from ASTM D4946-89(2017); the entire disclosure of which is hereby incorporated by reference. The block resistance is assigned a value from 1 to 10 where higher values are considered better than lower values. Block resistance is used to determine the ability of a paint to withstand sticking to itself after a given amount of time to dry. Clearly, less sticking is more desirable and corresponds to higher values of the block resistance. A value of 10 is considered perfect while a value of 1 is considered poor. Valued from 5 to 10 are considered as passing while lower values are considered failing.

TABLE 3
Block Resistance at room temperature and 120° F.

| Block | | | | | |
|---|---|---|---|---|---|
| Resistance | | | | | |
| (RT/120° F.) | | Sample 1 | Sample 2 | Sample 3 | Sample 4 |
| 4 | hours | 8/2 | 8/6 | 8/3 | 8/6 |
| Over night | | 7/2 | 8/6 | 8/6 | 9/7 |
| 3 | Day | 9/4 | 9/7 | 9/7 | 9/8 |
| 7 | Day | 9/7 | 9/8 | 9/8 | 9/8 |

TABLE 4
Block Resistance at room temperature and 120° F.

| | | | |
|---|---|---|---|
| Block | | | |
| Resistance | | | |
| (RT/120° F.) | Sample 5 | Sample 6 | Sample 7 |

| | | | | |
|---|---|---|---|---|
| 4 | hours | 9/7 | 9/6 | 8/2 |

| | | | |
|---|---|---|---|
| Over night | 9/8 | 9/8 | 8/4 |

| | | | | |
|---|---|---|---|---|
| 3 | Day | 9/8 | 9/8 | 8/6 |
| 7 | Day | 9/8 | 9/8 | 9/8 |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A scuff and mar-resistant paint composition comprising:
a base paint formulation; and
a slip additive dispersed in the base paint formulation, the slip additive having a surface energy less than about 40 mJ/m², the slip additive being in a sufficient amount such that slip resistance of a coating formed from the scuff and mar-resistant paint composition is decreased compared to a coating formed from the base paint formulation.

2. The scuff and mar-resistant paint composition of claim 1, wherein the base paint formulation is a latex paint formulation or an acrylic paint formulation.

3. The scuff and mar-resistant paint composition of claim 1, wherein the slip additive is a fluorinated slip additive or a silicone-containing slip additive.

4. The scuff and mar-resistant paint composition of claim 3, wherein the slip additive is a resin.

5. The scuff and mar-resistant paint composition of claim 1, wherein the slip additive is present in an amount from about 0.2 to 3.0% of the total weight of the scuff and mar-resistant paint composition.

6. The scuff and mar-resistant paint composition of claim 1, wherein the slip additive is present in an amount from about 0.5 to 2.0% of the total weight of the scuff and mar-resistant paint composition.

7. The scuff and mar-resistant paint composition of claim 1, wherein the slip additive is a silicone acrylic hybrid.

8. The scuff and mar-resistant paint composition of claim 1, wherein the slip additive is a silicone emulsion.

9. The scuff and mar-resistant paint composition of claim 1, wherein the slip additive is polydimethylsiloxane.

10. The scuff and mar-resistant paint composition of claim 1, wherein the slip additive is a blend or a synthetic wax and polytetrafluoroethylene.

11. A method of upgrading a manufactured base paint formulation, the method comprising:
receiving the manufactured base paint formulation; and
mixing a slip additive into the manufactured base paint formulation, the slip additive having a surface energy less than about 40 mJ/m², the slip additive being in a sufficient amount such that slip resistance of a coating formed from the manufactured base paint formulation with the slip additive mixed therein is decreased compared to a coating formed from the manufactured base paint formulation without the slip additive.

12. The method of claim 11, wherein the manufactured base paint formulation is a latex paint formulation or an acrylic paint formulation.

13. The method of claim 11, wherein the slip additive is a fluorinated slip additive or a silicone-containing slip additive.

14. The method of claim 11, wherein the slip additive is present in an amount from about 0.2 to 3.0% of the total weight of the sum of the manufactured base paint formulation and the slip additive.

15. The method of claim 11, wherein the slip additive is present in an amount from about 0.5 to 2.0% of the total weight of the scuff and mar-resistant paint composition.

16. The method of claim 11, wherein the slip additive is a silicone acrylic hybrid.

17. The method of claim 11, wherein the slip additive is a silicone emulsion.

18. The method of claim 11, wherein the slip additive is polydimethylsiloxane.

19. The method of claim 11, wherein the slip additive is a blend or a synthetic wax and polytetrafluoroethylene.

20. The method of claim 11, wherein the manufactured base paint formulation is a commercially available paint formulation.
